(19) United States
(12) Patent Application Publication
(10) Pub. No.: US 2004/0039556 A1
(43) Pub. Date: Feb. 26, 2004

(54) Filter models for dynamic control of complex processes

(75) Inventors: Wai T. Chan, Newburyport, MA (US); Jill P. Card, West Newbury, MA (US); An Cao, Arlington, MA (US)

Correspondence Address: TESTA, HURWITZ & THIBEAULT, LLP, HIGH STREET TOWER, 125 HIGH STREET, BOSTON, MA, 02110, US

(73) Assignee: Ibex Process Technology, Inc., Lowell, MA

(21) Appl. No.: 10/646,668

(22) Filed: Aug. 22, 2003

Related U.S. Application Data
(60) Provisional application No. 60/405,154, filed on Aug. 22, 2002.

(51) Int. Cl. G06F 17/10

(52) U.S. Cl. 703/2

(57) ABSTRACT

Non-linear regression models of a complex process and methods of modeling a complex process feature a filter based on a function of an input variable, the output of which is a predictor of the output of the complex process.

### CROSS-REFERENCE TO RELATED APPLICATION

This application claims priority to and the benefits of U.S. Provisional Application Serial No. 60/405,154, filed on Aug. 22, 2003, the entire disclosure of which is hereby incorporated by reference.

### FIELD OF THE INVENTION

The invention relates to the field of data processing and process control. In particular, the invention relates to the neural network control of multi-step complex processes.

### BACKGROUND

The manufacture of semiconductor devices requires hundreds of processing steps. In turn, each process step may employ several process tools. Each process tool may have several manipulable parameters—e.g. temperature, pressure and chemical concentrations—that affect the outcome of a process step. In addition, there may be associated with each process tool several maintenance parameters that impact process performance, such as the age of replaceable parts and the time since process tool calibration.

Both process manipulable parameters and maintenance parameters associated with a process may be used as inputs for a model of the process. However, these two classes of parameters have important differences. Manipulable parameters typically exert a predictable effect and do not exhibit non-linear time-dependent behavior. Maintenance parameters, on the other hand, affect the process outcome in a more sophisticated way. For example, the time elapsed since a maintenance event typically has a highly non-linear effect. However, the degree of non-linearity is often unknown. It is a challenge to build an accurate model of the effect of maintenance events on process outcome because prior knowledge of the degree of non-linearity is typically required for the model to be accurate. One way to handle this unknown non-linearity is to provide multiple initial estimates of the non-linear behavior for each maintenance parameter as a pre-processing step of the modeling effort, and rely on the model's ability to use only those estimates that capture the non-linear characteristics in the model. In a process model based on that approach, each maintenance parameter is represented by multiple input variables: there are typically one or more initial estimates of the non-linear behavior for each maintenance parameter.

Unfortunately, the processing time for a model typically increases exponentially with the number of input variables. The processing time may also increase as a result of inaccurate initial estimates. This approach, therefore, runs counter to the desirability of modeling complex processes with a minimum number of input variables. Accordingly, models of complex processes that avoid adding extra input variables to address the unknown behavior of other input variables, and methods for building such models, are needed.

### SUMMARY OF THE INVENTION

The present invention facilitates construction of non-linear regression models of complex processes in which the outcome of the process is better predicted by the output of a function of an input variable having at least one unknown parameter that characterizes the function than by the input variable itself. The present invention avoids the creation of extra variables in the initial input variable set and may improve the performance of model training. No initial estimates of the unknown parameter(s) that characterize the function of the input variables and related preprocesses are required. Preferably, the non-linear regression models used in the present invention comprise a neural network.

In one aspect, the present invention comprises a method of modeling a complex process having a plurality of input variables, a portion of which have unknown behavior that can be described by a function. The function, in turn, comprises at least one unknown parameter and produces an output that is a better predictor of outcome of the process than the associated input variable itself. The method comprises providing a non-linear regression model of the process and using the model to predict the outcome of the process. The model comprises a plurality of first connection weights that relate the plurality of input variables to a plurality of process metrics. The model also comprises a function and a plurality of second connection weights that relate input variables in the portion to the plurality of process metrics. Each of the plurality of second connection weights correspond to an unknown parameter associated with an input variable in the portion. In some embodiments, the plurality of second connection weights are derived by a method of building the model of a complex process. In some embodiments, the non-linear regression model has at least a first hidden layer and a last hidden layer. The first hidden layer has a plurality of nodes, each of which corresponds to an input variable with unknown behavior. In these embodiments, each node in the first hidden layer relates an input variable with the function and a second connection weight. In such embodiments, more hidden layers may be added if the function comprises two or more unknown parameters.

In another aspect, the present invention comprises a method of building a non-linear regression model of a complex process having a plurality of input variables. A portion of the input variables exhibit unknown behavior that can be described by a function having at least one unknown parameter. These input variables may, in some embodiments, be input variables for a first hidden layer of the model having a plurality of nodes. In these embodiments, each node in the first hidden layer is associated with one of the input variables and has a single synaptic weight. In accordance with the method, a function of an input variable that has at least one unknown parameter and whose output is a predictor of output of the process is identified. A model comprising a plurality of connection weights that relate the plurality of input variables to a plurality of process metrics is provided, and an error signal for the model is determined. The one or more unknown parameters of the function and the plurality of connection weights are adjusted in a single process based on the error signal. In some embodiments, the one or more unknown parameters initially comprise values that are randomly assigned. In other embodiments, the one or more unknown parameters initially comprise the same arbitrarily assigned value. In other embodiments, the one or more unknown parameters initially comprise one or more estimated values. For example, the error signal may be used in part to determine a gradient for a plurality of outputs of the first hidden layer, and the adjustment may be made to one or more of the synaptic weights corresponding to one or more unknown parameters of the function. The adjustment process (e.g., to one or more of the synaptic weights) is repeated until a convergence criterion is satisfied.

In some embodiments, the invention involves the model of a complex process that features a set of initial input variables comprising both manipulated variables and maintenance variables. As used herein, the term “manipulable variables” refers to input variables associated with the manipulable parameters of a process. The term “manipulable variables” includes, for example, process step controls that can be manipulated to vary the process procedure. One example of a manipulable variable is a set point adjustment. As used herein, the term “maintenance variables” refers to input variables associated with the maintenance parameters of a process. The term “maintenance variables” includes, for example, variables that indicate the wear, repair, or replacement status of a sub-process component(s) (referred to herein as “replacement variables”), and variables that indicate the calibration status of the process controls (referred to herein as “calibration variables”).

In various embodiments, the non-linear regression model comprises a neural network. A neural network can be organized as a series of nodes (which may themselves be organized into layers) and connections among the nodes. Each connection is given a weight corresponding to its strength. For example, in one embodiment, the non-linear regression model comprises a first hidden layer that serves as a filter for specific input variables (organized as nodes of an input layer with each node corresponding to a separate input variable) and at least a second hidden layer that is connected to the first hidden layer and the other input variables (also organized as nodes of an input layer with each node corresponding to a separate input variable). The first hidden layer utilizes a single neuron (or node) for each input variable to be filtered.

The second hidden layer may be fully connected to the first hidden layer and to the input variables that are not connected to the first hidden layer. In some embodiments, the second layer is not directly connected to the input variables that are connected to the first hidden layer, whereas in other embodiments, the second hidden layer is fully connected to the first hidden layer and to all of the input variables.

In one embodiment, the outputs of the second hidden layer are connected to the outputs of the non-linear regression model, i.e., the output layer. In other embodiments, the non-linear regression model comprises one or more hidden layers in addition to the first and second hidden layers; accordingly, in these embodiments the outputs of the second hidden layer are connected to another hidden layer instead of the output layer.

In some embodiments, the function associated with an input variable comprises two unknown parameters. In some such embodiments, the non-linear regression model comprises two hidden filter layers having a plurality of nodes each corresponding to an input variable in the portion. Such embodiments involve filtering the input variables with the two hidden filter layers, using a synaptic weight for each input variable and each hidden filter layer. Each of these synaptic weights corresponds to one of the two unknown parameters in the function.

In other aspects, the present invention provides systems adapted to practice the aspects of the invention set forth above. In some embodiments of these aspects, the present invention provides an article of manufacture in which the functionality of portions of one or more of the foregoing methods of the present invention are embedded on a computer-readable medium, such as, but not limited to, a floppy disk, a hard disk, an optical disk, a magnetic tape, a PROM, an EPROM, CD-ROM, or DVD-ROM.

In another aspect, the invention comprises an article of manufacture for building a non-linear regression model of a complex process having a plurality of input variables, a portion of which have unknown behavior that can be described by a function comprising at least one unknown parameter. The function produces an output that is a predictor of the outcome of the process. The article of manufacture includes a process monitor, a memory device, and a data processing device. The data processing device is in signal communication with the process monitor and the memory device. The process monitor provides data representing the plurality of input variables and the corresponding plurality of process metrics. The memory device provides the function and a plurality of first weights corresponding to the at least one unknown parameter associated with each of input variables in the portion. In some embodiments, the plurality of second connection weights comprise values that are randomly assigned. In other embodiments, the plurality of second connection weights all comprise the same arbitrarily assigned initial value. In other embodiments, the plurality of second connection weights comprise one or more estimated values. The data processing device receives the data, the function, and the plurality of first weights and determines an error signal of the model from them. The data processing device adjusts the plurality of first weights and a plurality of second weights that relate a plurality of input variable to the plurality of process metrics, in a single process based on the error signal.

In embodiments of the foregoing aspect, the data processing device determines the error signal for the output layer of the model and uses the error signal to determine a gradient for the output of the function associated with each input variable in the portion, and adjust the weight corresponding to the at least one unknown parameter accordingly.

In embodiments of the foregoing aspect, the data processing device also determines if a convergence criterion is satisfied. In some such embodiments, the data processing device will adjust the weights again if the convergence criterion is not satisfied or terminate the process if the convergence criterion is satisfied.

In another aspect, the invention comprises an article of manufacture for modeling a complex process having a plurality of input variables, a portion of which have unknown behavior that can be described by a function comprising at least one unknown parameter. The function produces an output that is a predictor of the outcome of the process. The article of manufacture includes a process monitor, a memory device, and a data processing device. The data processing device is in signal communication with the process monitor and the memory device. The process monitor provides data representing the plurality of input variables. The memory device provides a plurality of first connection weights that relate the plurality of input variables to a plurality of process metrics, the function, and a plurality of second weights corresponding to the at least one unknown parameter associated with each of input variables in the portion. In some embodiments, the plurality of second weights are derived by an article of manufacture for building a non-linear regression model of a complex process. The data processing device receives the plurality of input variables, the plurality of first connection weights, the function, and the plurality of second connection weights; and predicts an outcome of the complex process in a single process using that information.

In embodiments of the foregoing aspects, the process monitor comprises a database or a memory element including a plurality of data files. In some embodiments, the data representing input variables and process metrics include binary values and scalar numbers. In some such embodiments, one or more of scalar numbers is normalized with a zero mean. In embodiments of the foregoing aspects, the memory device is any device capable of storing information, such as a floppy disk, a hard disk, an optical disk, a magnetic tape, a PROM, an EPROM, CD-ROM, or DVD-ROM. In some such embodiments, the memory device stores information in digital form. In embodiments of the foregoing aspects, the memory device is part of the process monitor. In embodiments of the foregoing aspects, the data processing device comprises a module embedded on a computer-readable medium, such as, but not limited to, a floppy disk, a hard disk, an optical disk, a magnetic tape, a PROM, an EPROM, CD-ROM, or DVD-ROM.

In various embodiments of the foregoing aspects, the function for the unknown behavior is non-linear with respect to the input variable. In some such embodiments, the input variable represents a time elapsed since an event associated with the complex process. In one such embodiment, the function is of the form exp(−λⱼyⱼ) where λⱼ is the synaptic weight associated with an input yⱼ, and wherein the input yⱼ is an input variable of the portion of the plurality input variables. The input yⱼ in such an embodiment may represent the time elapsed since a maintenance event. In various embodiments, the input variables comprise, but are not limited to, continuous values, discrete values, and binary values.

In some embodiments of the foregoing aspects, the adjustment is of the form Δλⱼ=−ηyⱼδⱼ where η is a learning rate parameter, δⱼ is the gradient of an output of a node j of the first hidden layer with the input yⱼ, Δλⱼ is the adjustment for synaptic weight λⱼ associated with the input yⱼ, and the input yⱼ is an input variable of the portion of the plurality input variables.

### BRIEF DESCRIPTION OF THE DRAWINGS

A more complete understanding of the advantages, nature, and objects of the invention may be attained from the following illustrative description and the accompanying drawings. The drawings are not necessarily drawn to scale, and like reference numerals refer to the same parts throughout the different views.

FIG. 1A is a schematic representation of one embodiment of a non-linear regression model for a complex process according to the present invention;

FIG. 1B is a schematic representation of another embodiment of a non-linear regression model for a complex process according to the present invention;

FIG. 1C is a schematic representation of a third embodiment of a non-linear regression model for a complex process according to the present invention;

FIGS. 2 is a flow diagram illustrating building a non-linear regression model according to one embodiment of the present invention; and

FIGS. 3A and 3B are a flow diagram illustrating one embodiment of building a non-linear regression model according to the present invention.

FIG. 4 is a system in accordance with embodiments of the present invention.

### ILLUSTRATIVE DESCRIPTION

An illustrative description of the invention in the context of a neural network model of a complex process follows. However, one of ordinary skill in the art will understand that the present invention may be used in connection with other non-linear regression models that have input variables with unknown behavior and that describe complex processes whose outcome is better predicted by a function of such variables than by the input variables themselves.

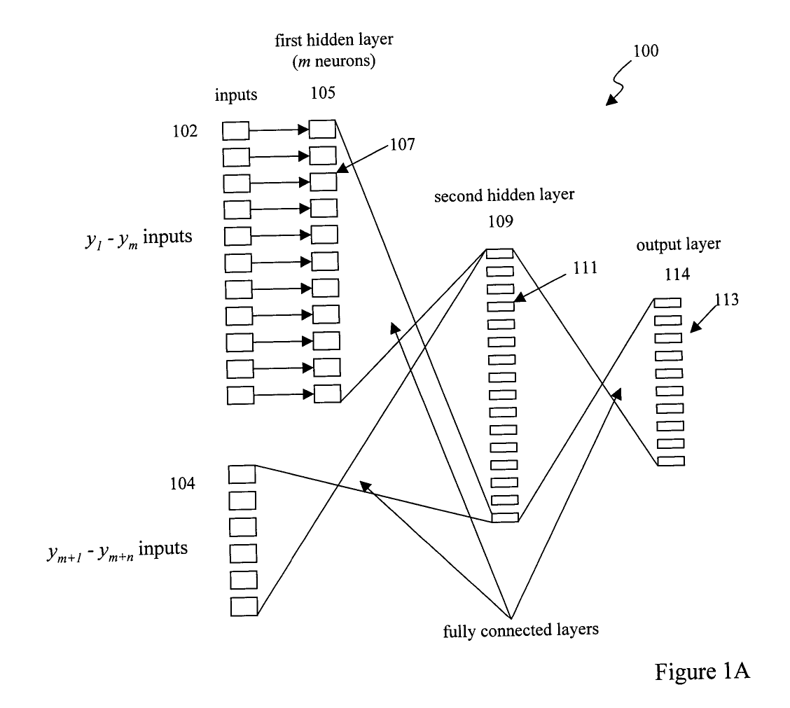

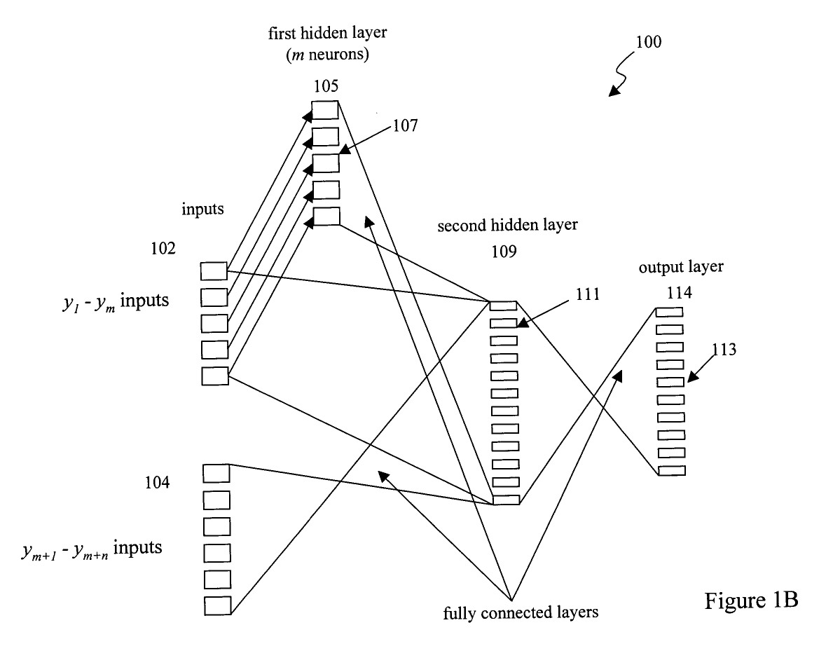

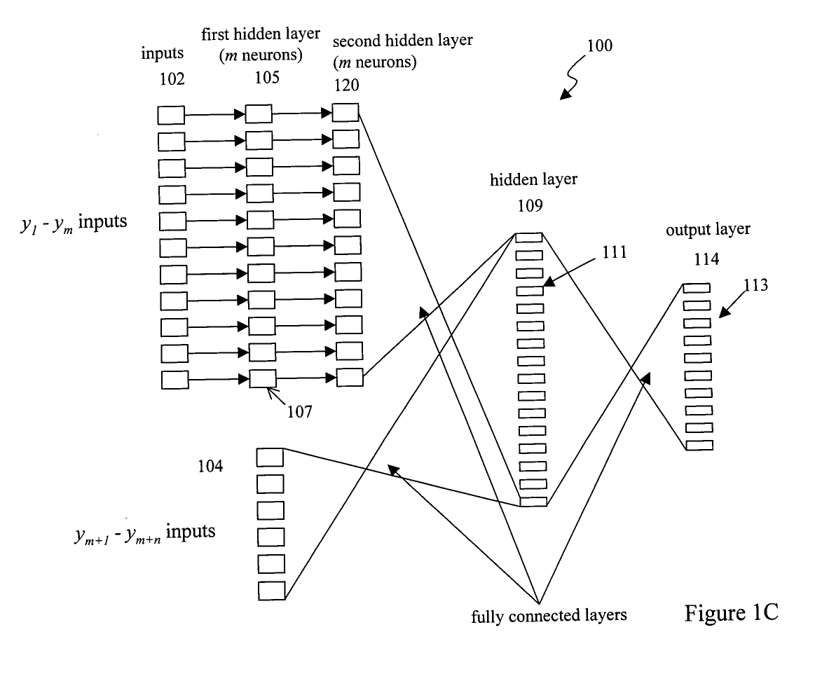

In the illustrative example, the initial non-linear regression model comprises a neural network model. As illustrated in FIGS. 1A, 1B, and 1C, the neural network model 100 has m+n input variables y. The first m input variables (y₁, . . . yₘ) 102 are variables to be filtered. In some embodiments, these m variables represent maintenance variables, which have an unknown non-linear, time-dependent behavior that affects process outcome. The remaining n input variables (Yₘ₊₁, yₘ₊ₙ) 104 are variables that will not be filtered. In this example, these n variables represent manipulated variables that do not exhibit non-linear time behavior. The first hidden layer 105 of the neural network comprises m nodes 107 (indexed by j) and serves as a filter layer for the maintenance variables 102. There is a one-to-one connection between the input nodes 1 through m and the filter layer nodes 107. If we denote the nodes in this first layer 105 by node 1 through m, then for j=1, . . . , m, the input to node j is yⱼ with a synaptic weight λⱼ. Thus, no extra input variables are added to model the maintenance variables.

In the embodiments illustrated in FIGS. 1A and 1B, each node 107 in the first hidden layer 105 has an activation function with one unknown parameter. In the illustrative embodiment in particular, the activation function associated with each node 107 in the first hidden layer 105 is an exponential function of the form:

φ(x)=exp(−x) Eq. (1).

This choice of exponential function is related to a practice in reliability engineering, which models the reliability of a part at age t by the exponential distribution exp(−λt). As a result, the output from the first hidden layer 105 for each node j is exp(−λⱼyⱼ).

In one alternative embodiment, the activation function is another parametric form of the reliability function. In other embodiments, the activation function comprises, for example, a Weibull distribution,

$$exp ( - {λ}_{j} {y}_{j}^{{β}_{j}} ) ,$$

a lognormal distribution, and a gamma distribution,

$${\int }_{0}^{t} ( {x}^{α - 1} {ⅇ}^{- x} ) / Γ ( α ) ⅆ x .$$

These are the typical probability models used in engineering and biomedical applications. Accordingly, it is to be understood that the present invention is not limited to exponential activation functions.

Referring to FIG. 1A, in one embodiment, the second hidden layer 109, contains K nodes 111 where each node k=1, . . . , K is connected to each node 107 of the first hidden layer 105 in accordance with the respective connection weight (i.e., the nodes are fully connected) and is also connected to each of the input manipulated variables 104. The second hidden layer 109 is in turn fully connected to the output layer 114 (i.e., all nodes 111 can contribute to the value of each of the nodes 113 in the output layer).

Referring to the alternative illustrative embodiment of FIG. 1B, there is again a one-to-one connection between the input nodes 1 through m and the nodes of the first hidden layer 105. Unlike in the embodiment of FIG. 1A, the K nodes 111 in the second hidden layer 109 are directly connected to each of the input maintenance variables 102 as well as to each node 107 of the first hidden layer 105 and to each of the input manipulated variables 104. Thus, if the maintenance variables 102 have other contributions that are not sufficiently captured by the first hidden layer 105, the model can compensate by adjusting the weights directly from the input maintenance nodes (variables) 102. As in FIG. 1A, the second hidden layer 109 is also fully connected to the output layer 114.

In an embodiment that incorporates an activation function with two unknown parameters, a non-linear regression model such as that illustrated in FIG. 1C may be used. As in FIGS. 1A and 1B, the model depicted in FIG. 1C features a one-to-one connection between the input nodes 1 through m and the nodes of the first hidden layer 105. Unlike in the embodiments of FIGS. 1A and 1B, however, FIG. 1C features a second hidden filter layer 120 between the first hidden layer 105 and hidden layer 109. There is a one-to-one connection between the nodes of the first hidden layer 105 and the nodes of hidden filter layer 120. In some embodiments there is also a one-to-one connection between the input layer 102 and the nodes of hidden filter layer 120. Thus, there is one filter layer associated with each unknown parameter in the filter function. The k nodes 111 in hidden layer 109 are connected to each node j of hidden layer 120 and to each of the input manipulated variables 104. As in FIGS. 1A and 1B, hidden layer 109 is also fully connected to the output layer 114 in FIG. 1C.

As in the embodiments of FIGS. 1A and 1B, each node 107 in the first hidden layer 105 of FIG. 1C has an activation function with one unknown parameter. In the embodiment illustrated in FIG. 1C, each node in hidden layer 120 also has an activation function with one unknown parameter. As an illustrative example, the Weibull distribution can be implement using FIG. 1C as follows: If the input to node j in layer 102 is yⱼ, an input of log (yⱼ) will be fed forward to a node in layer 105. The synaptic weight between a node in layer 102 and layer 105 may be designated βⱼ and the synaptic weight between a node in layer 105 and layer 120 may be designated λⱼ. Each node in hidden layer 105 has activation function of the form φ(x)=exp(x) and each node in hidden layer 120 has activation function of the form φ(x)=exp(−x). As a result, the output from the first hidden layer 105 for each node j is

$$exp ( {β}_{j} log ( {y}_{j} ) ) = {y}_{j}^{{β}_{j}}$$

and the output from the second hidden layer 120 for each node j is

$$exp ( - {λ}_{j} {y}_{j}^{{β}_{j}} ) .$$

Thus, no extra input variables are added to model the maintenance variables.

In an alternative embodiment similar to FIG. 1B, the K nodes 111 in FIG. 1C are also directly connected to each of the input maintenance variables 102 to capture any contributions that are not sufficiently captured by hidden layers 105 and 120.

The present invention also provides methods and systems for building non-linear regression models that incorporate such a filter layer. The model building begins with the recognition that one or more input variables are not optimally used to predict output of the process directly. Instead, the input variable is a better predictor of the output of the process after it has been pre-processed or filtered. In particular, there is a function of the input variable whose output is a better predictor of the output of the process than the input variable itself. This function, however, is characterized by at least one unknown parameter and therefore cannot be used directly. The function may be referred to as an activation function. The filter layer enables at least one unknown parameter in the function to be estimated and the output of the function to be used as the predictor of the output of the process.

The non-linear regression model of the illustrative example is built by comparing a calculated output variable, based on measured maintenance and manipulated variables for an actual process run, with a target value based on the actual output variables as measured for the actual process run. The difference between calculated and target values (such as, e.g., measured process metrics), or the error, is used to compute the corrections to the adjustable parameters in the regression model. Where the regression model is a neural network as in the illustrative example, these adjustable parameters are the connection weights between the nodes in the network.

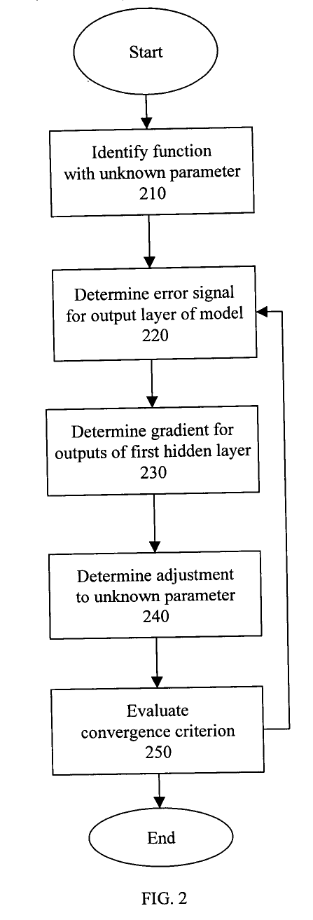

FIG. 2 illustrates the basic process of building a non-linear regression model of a complex process that incorporates a filter layer in accordance with the invention. In step 210, an activation function of an input variable is identified. The output of the function is a predictor of the outcome of the complex process. The function, however, is characterized by at least one unknown parameter. The function is typically identified based on knowledge about the relationship between an input variable and the outcome of the process.

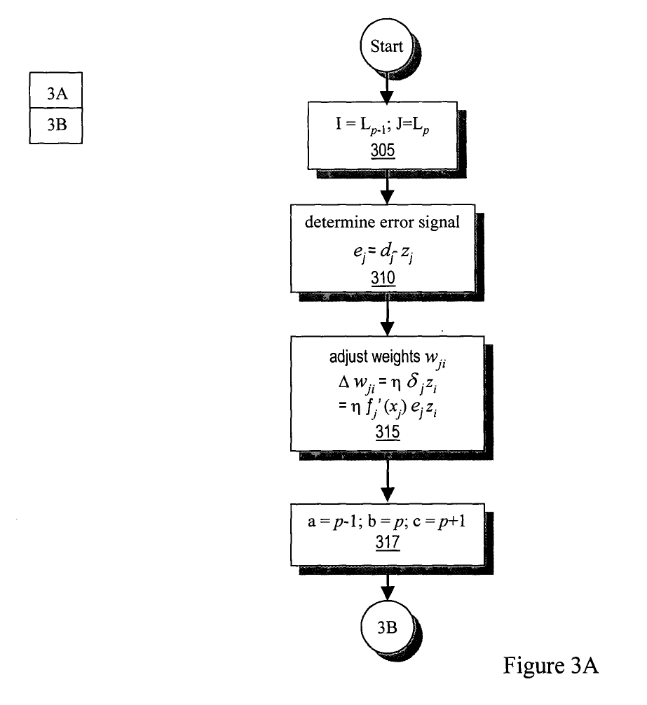

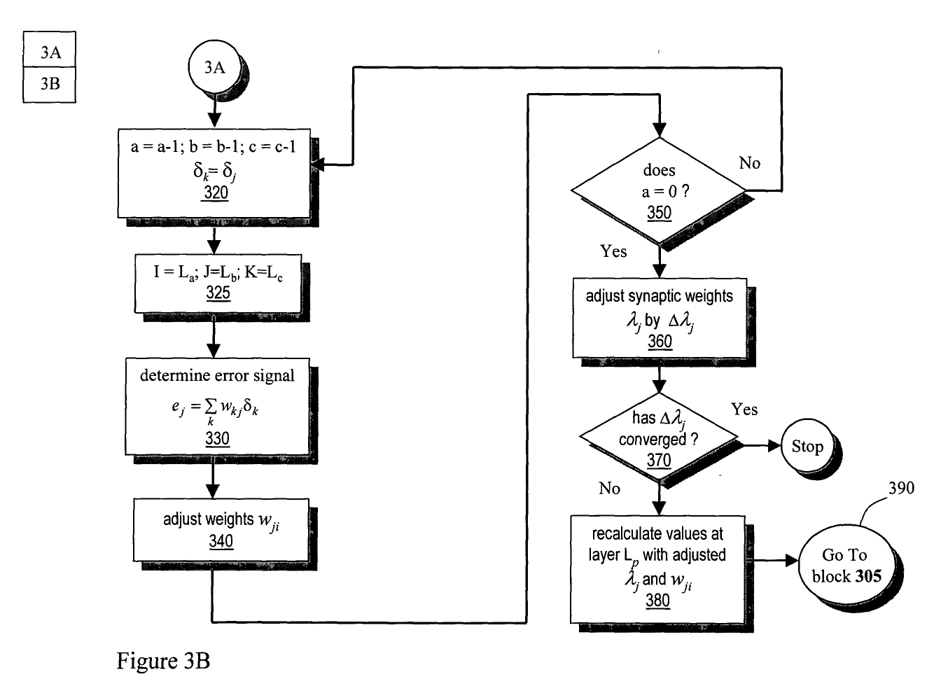

In step 220, an error signal for an output layer of the non-linear regression model in accordance with the embodiments is determined. In step 230, a gradient for each of the outputs of the first hidden layer is determined using the error signal. In step 240, an adjustment to one or more of the synaptic weights corresponding to one or more unknown parameters is determined. In the model itself and in the process of building the model, only those synaptic weights between the input layer and the one or more filter layers correspond to one or more unknown parameters of an activation function. Other synaptic weights in the model may be calculated, for example, using standard equations known to be useful for calculating such weights in neural networks. An embodiment of the invention featuring steps similar to step 220 through step 240 is described in detail below with respect to FIGS. 3A and 3B.

In optional step 250 of FIG. 2, a convergence criterion is evaluated. If the convergence criterion is not satisfied, steps 210 through 250 are repeated. In one embodiment, the process is repeated using the same set of input variables and corresponding output variables measured from an actual run of the process. In another embodiment, the process is repeated using a different set of input variables and corresponding output variables measured from an actual run of the process. If the convergence criterion is satisfied, the process ends and the model is complete.

Illustrated in FIGS. 3A and 3B is a flow diagram of one embodiment of a process for building a non-linear regression model, in this example a neural network, having p+1 layers Lᵥ (where v=0, 1, . . . , p−1, p), inclusive of an input layer Lᵥ₌₀ and an output layer Lᵥ₌ₚ. As used in FIGS. 3A and 3B, the indices i,j, k and layer designations I, J and K have the following meanings: the index i spans the nodes of a layer I; the index j spans the nodes of a layer J; and the index k spans the nodes of a layer K, where the output of layer I serves as the input to layer J and the output of layer J serves as the input to layer K.

Referring to FIG. 3A, the building approach starts with the output layer J=Lₚ and its predecessor layer I=Lₚ₋₁ (block 305) to determine the output layer error signals eⱼ (block 310); accordingly, no layer K is used at this stage. As illustrated in FIG. 3A, the output layer Lₚ error signals eⱼ may be determined from

eⱼ=dⱼ−zⱼ Eq. (2),

where dⱼ represents the desired output (or target value) of node j and zⱼ represents the actual output value of node j. The error signals eⱼ are then used to adjust the weights wⱼᵢ connecting layers I and J (block 315). The adjustment Δwⱼᵢ to a weight wⱼᵢ may be determined from

Δwⱼᵢ=ηδⱼzᵢ Eq. (3),

where η denotes the learning-rate parameter, δⱼ is the gradient of error against node inputs xⱼ for the output of node j, and zᵢ represents the output of node I (i.e., the input through connection weight wⱼᵢ in to node j). The gradient δⱼ may be determined from

δⱼ=ƒⱼ′(xⱼ)eⱼ Eq. (4),

where ƒⱼ is the activation function for node j.

After the weights wⱼᵢ are adjusted to (wⱼᵢ+Δwⱼᵢ), the approach is continued back through the non-linear regression model. In accordance with FIGS. 3A and 3B, now layer I=Lₐ₌ₚ₋₂, layer J=L_{b=p-1} and layer K=L_{c=p} (blocks 317, 320, and 325). As a result, the weights wₖⱼ connecting layers J and K are the previously determined adjusted weights (wⱼᵢ+Δwⱼᵢ) (block 315).

The approach back-propagates through the non-linear regression model using the gradient δₖ at the output of the nodes k to determine the error signals eⱼ of the new layer J=L_{b} (block 330). For example, at a node j the gradient δⱼ is the product of ƒⱼ′(xⱼ) and the weighted sum of the δs computed for the nodes in layer K that are connected to node j. Accordingly, the layer J error signals eⱼ may be determined from,

$${e}_{j} = {\sum }_{k} {w}_{k j} {δ}_{k} , \qquad Eq . ( 5 )$$

and the gradient δⱼ from,

$${δ}_{j} = {f}_{j}^{′} ( {x}_{j} ) {\sum }_{k} {w}_{k j} {δ}_{k} , \qquad Eq . ( 6 )$$

where the summing of both equations (5) and (6) occurs over all nodes in layer K that are connected to layer J. The error signals eⱼ are then used to adjust the weights wⱼᵢ connecting layers I and J (block 340). This adjustment Δwⱼᵢ to a weight wⱼᵢ may then be determined from

$$Δ {w}_{j i} = η {z}_{i} {f}_{j}^{′} ( {x}_{j} ) {\sum }_{k} {w}_{k j} {δ}_{k} , \qquad Eq . ( 7 )$$

as illustrated in FIG. 3B.

The approach continues to back-propagate the error signals layer by layer through the non-linear regression model until the gradients δⱼ of the nodes j of the first hidden layer J=L₁ can be determined (i.e., until I=Lₐ₌₀ and the answer to query 350 is “YES”). As previously discussed, the activation function ƒ(x) used in the illustrative embodiment for the filtered input variables is of the form φ(x)=exp(−x), and the inputs to a node are yⱼ and λⱼ where yⱼ is the jth input to the neural network and λⱼ is the synaptic weight of connection between the jth node in the input layer and the jth node in the first hidden layer. The gradient δⱼ at node j may then be given by

$${δ}_{j} = - exp ( - {λ}_{j} {y}_{j} ) {\sum }_{k ∈ {C}_{j}} {w}_{k j} {δ}_{k} , \qquad Eq . ( 8 )$$

where Cⱼ is the set of nodes in the second hidden layer K that are connected to node j.

The building approach then adjusts the synaptic weights λⱼ of the activation function (block 360) using the gradients δⱼ. Thus, the adjustment Δλⱼ to the synaptic weight λⱼ may be given by

$$Δ {λ}_{j} = - η {y}_{j} {δ}_{j} = - η {y}_{j} exp ( - {λ}_{j} {y}_{j} ) {\sum }_{k ∈ {C}_{j}} {w}_{k j} {δ}_{k} . \qquad Eq . ( 9 )$$

The building approach of FIGS. 3A and 3B is then repeated until the change in the adjustment terms Δλⱼ satisfies a convergence criterion. A typical convergence criterion first defines a tolerance factor which indicates a meaningful improvement in the average prediction accuracy over all training records. If the convergence criterion is satisfied (“YES” to query 370) then the building round is ended. If the convergence criterion is not satisfied (“NO” to query 370) then the outputs of the model, i.e., the values of the nodes of the output layer Lₚ, are recalculated (block 380) using the adjusted connection weights (wⱼᵢ+Δwⱼᵢ) and adjusted synaptic weights (λⱼᵢ+Δλⱼᵢ). The process of error signal determination and weight correction is then repeated (action 390). The process is thus preferably repeated until the convergence criterion is satisfied. In one such embodiment, the process is not repeated if the average prediction accuracy has not improved within the tolerance factor for a pre-determined number of process iterations.

The building approach illustrated by FIGS. 3A and 3B may be utilized with a single set of target values dⱼ (e.g., a set of measured maintenance and manipulated variables and measured output values for a single process run, or a set of averaged measured maintenance and manipulated variables and measured output values for a plurality of process runs) or multiple sets of target values dⱼ.

Preferably, the building approach of the present invention is conducted for a plurality of sets of target values dⱼ. For example, in one embodiment, the building approach conducts a first building run utilizing a first set of target values dⱼ and determines synaptic weight adjustments until a first convergence criterion is satisfied. The approach then uses the adjusted connection weights (wⱼᵢ+Δwⱼᵢ) and adjusted synaptic weights (λⱼᵢ+Δλⱼᵢ) determined in the first building run to conduct a second building run utilizing a second set of target values dⱼ and determines synaptic weight adjustments until a second convergence criterion is satisfied. The approach continues with additional building runs utilizing third, fourth, etc., sets of target values dⱼ with the adjusted weights from the prior building run.

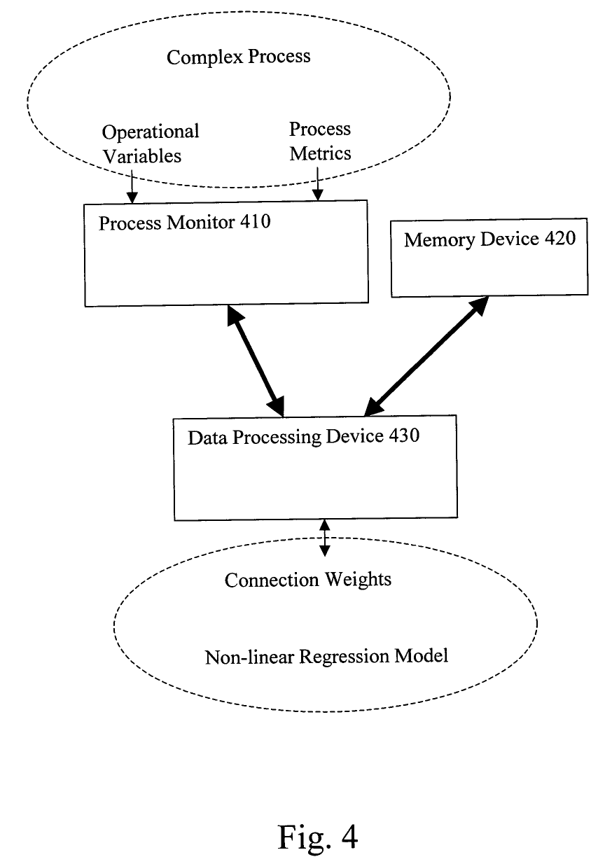

In other aspects, the present invention provides systems and articles of manufacture adapted to practice the methods of the invention set forth above. In embodiments illustrated by FIG. 4, the system comprises a process monitor 410, a memory device, and a data processing device 430. In these embodiments, the data processing device 430 is in signal communication with the process monitor 410 and the memory device 420. A system or article of manufacture in accordance with FIG. 4 may build a non-linear regression model of a complex process having a plurality of input variables, a portion of which exhibit unknown behavior that can be described by a function comprising at least one unknown parameter, or model such a process, or both.

The process monitor 410 may comprise any device that provides data representing input variables and/or corresponding process metrics associated with the process. The process monitor 410 in some embodiments, for example, comprises a database that includes data from process sensor, yield analyzers, or the like. In related embodiments, the process monitor 410 is a set of files from a statistical process control database. Each file in the process monitor 410 may represent information relating to a specific process. The information may include binary values and scalar numbers. The binary values may indicate relevant technology and equipment used in the process. The scalar numbers may represent process metrics. The process metrics may be normalized. The normalization may have a zero mean and/or a unity standard deviation.

The memory device 420 illustrated in FIG. 4 may comprise any device capable of storing a function, a plurality of first weights representing at least one unknown parameter from the function associated with an input variable in the portion, and, in some embodiments, a plurality of second weights that relate the plurality of input variables to the plurality of process metrics. In some embodiments, the plurality of weights initially comprise values that are randomly assigned. In other embodiments, the plurality of weights initially comprise the same arbitrarily assigned initial value. In other embodiments, the plurality of weights initially comprise one or more estimated values. The memory device 420 provides the stored information to the data processing device 430. A memory device 420 may, for example, be a floppy disk, a hard disk, an optical disk, a magnetic tape, a PROM, an EPROM, CD-ROM, or DVD-ROM. In some such embodiments, the memory device stores information in digital form. The memory device 420 in some embodiments, for example, comprises a database. The memory device 420 in some embodiments is part of the process monitor 410. In some embodiments, the invention further comprises a user interface that enables the function and/or weights in the memory device 420 to be input or directly modified by the user.

The data processing device 430 may comprise an analog and/or digital circuit adapted to implement portions of the functionality of one or more of the methods of the present invention using at least in part data from the process monitor 410 and the function from the memory device 420. In some embodiments, the data processing device 430 uses data from the process monitor 410 to adjust the weights in the memory device 420. In some embodiments, the data processing device 430 sends the adjusted weights back to the memory device 420 for storage. In some such embodiments, the data processing device 430 may adjust a weight by determining the error signal for the output layer of the model and using the error signal to determine a gradient for the output of the function. In some such embodiments, the data processing device 430 also evaluates a convergence criterion and adjusts the weights again if the criterion is not met. In other embodiments, the data processing device 430 uses the function and the weights in the memory device 420, along with input variable from the process monitor 410, to predict outcome of the process. In addition, in one embodiment, data processing device 430 is adapted to adjust the weights after a process outcome is predicted thereby improving the model and its filtering continually.

In some embodiments, the data processing device 430 may implement the functionality of portions of the methods of the present invention as software on a general-purpose computer. In addition, such a program may set aside portions of a computer's random access memory to provide control logic that affects the non-linear regression model implementation, non-linear regression model training and/or the operations with and on the input variables. In such an embodiment, the program may be written in any one of a number of high-level languages, such as FORTRAN, PASCAL, C, C++, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

What is claimed is:

1. A method of modeling a complex process having a plurality of input variables, a portion of which have unknown behavior that can be described by a function comprising at least one unknown parameter and producing an output that is a predictor of outcome of the process, the method comprising the steps of:
providing a non-linear regression model of the process comprising:
a plurality of first connection weights that relate the plurality of input variables to a plurality of process metrics; and
a function and a plurality of second connection weights that relate input variables in the portion to the plurality of process metrics, wherein each of the plurality of second connection weights correspond to an unknown parameter associated with an input variable in the portion; and
using the model to predict an outcome of the process.

2. The method of claim 1, wherein the model has at least a first hidden layer and a last hidden layer, the first hidden layer having a plurality of nodes each corresponding to input variables in the portion, each node in the first hidden layer relating to an input variable with the function and a second connection weight, the second connection weight corresponding to the at least one unknown parameter.

3. The method of claim 2, wherein the last hidden layer is connected to nodes in the first hidden layer and nodes associated with input variables that are not in the portion.

4. The method of claim 3, wherein the function comprises two unknown parameters and can be represented by a first function with a first unknown parameter and a second function with a second unknown parameter, the method further comprising:
providing a non-linear regression model of the process comprising:
a first hidden layer, a second hidden layer, and a last hidden layer, the second hidden layer having a plurality of nodes each corresponding to one of the plurality of nodes in the first hidden layer,
a first function and a plurality of second connection weights that relate input variables in the portion to nodes in the first hidden layer, wherein each of the plurality of second connection weights correspond to a first unknown parameter associated with an input variable in the portion;
a second function and a plurality of third connection weights that relate nodes in the first hidden layer to nodes in the second hidden layer, wherein each of the plurality of third connection weights correspond to a second unknown parameter associated with an input variable in the portion; and
a plurality of first connection weights that relate the plurality of input variables not in the portion and nodes in the second hidden layer to a plurality of process metrics.

5. The method of claim 1, wherein the function is non-linear with respect to the input variable.

6. The method of claim 5, wherein the input variable represents a time elapsed since an event associated with the complex process.

7. The method of claim 1, wherein the input variables in the portion of the plurality of input variables are maintenance variables of a complex manufacturing process and the other input variables are manipulable variables.

8. The method of claim 1, wherein the function is an activation function of the form
exp(−λⱼyⱼ)
where λⱼ is the synaptic weight associated with an input yⱼ, and the input yⱼ is an input variable in the portion.

9. The method of claim 8, wherein the input yⱼ represents a time elapsed since a maintenance event.

10. The method of claim 1, wherein the input variable comprises a discrete value.

11. A method of building a non-linear regression model of a complex process having a plurality of input variables, a portion of which have unknown behavior that can be described by a function comprising at least one unknown parameter and producing an output that is a predictor of outcome of the complex process, the method comprising the steps of:
(a) identifying the function;
(b) providing a model comprising a plurality of connection weights that relate the plurality of input variables to a plurality of process metrics;
(c) determining an error signal for the model;
(d) adjusting the one or more unknown parameters of the function and the plurality of connection weights in a single process based on the error signal; and
(e) repeating steps (c) and (d) until a convergence criterion is satisfied.

12. The method of claim 11 wherein:
a portion of the input variables are input variables for a first hidden layer of the non-linear regression model, the first hidden layer having a plurality of nodes each associated with one of the input variables of the portion and having a single synaptic weight;
the identified function relates to an input variable from the portion;
the error signal is determined for an output layer of the non-linear regression model; and
the error signal is used to determine a gradient for a plurality of outputs of the first hidden layer.

13. The method of claim 11, wherein the function is non-linear with respect to the input variable.

14. The method of claim 13, wherein the input variable represents a time elapsed since an event associated with the complex process.

15. The method of claim 1 1, wherein the input variable in the portion of the plurality of input variables are maintenance variables of a complex manufacturing process.

16. The method of claim 1 1, wherein the function is an activation function of the form
exp(−λⱼyⱼ)
where λⱼ is the synaptic weight associated with an input yⱼ, and the input yⱼ is an input variable of the portion of the plurality input variables.

17. The method of claim 16, wherein the adjustment is of the form
Δλⱼ=−ηyⱼδⱼ
where η is a learning rate parameter, δⱼ is the gradient of an output of a node j of the first hidden layer with the input yⱼ, Δλⱼ is the adjustment for synaptic weight λⱼ associated with the input yⱼ, and the input yⱼ is an input variable of the portion of the plurality input variables.

18. An article of manufacture comprising a computer-readable medium having computer-readable instructions for
determining an error signal for an output layer of a non-linear regression model of a complex process, the model having a plurality of input variables of which a portion are input variables for a first hidden layer of the model having a plurality of nodes, each node associated with one of the input variables of the portion and having a single synaptic weight;
using the error signal to determine a gradient for a plurality of outputs of the first hidden layer;
determining an adjustment to one or more of the synaptic weights corresponding to one or more unknown parameters of a function; and
evaluating a convergence criterion and repeating foregoing steps if the convergence criterion is not satisfied,
wherein the computer-readable medium is in signal communication with a memory device for storing the function and the one or more synaptic weights.

19. An article of manufacture for building a non-linear regression model of a complex process having a plurality of input variables, a portion of which have unknown behavior that can be described by a function comprising at least one unknown parameter and producing an output that is a predictor of outcome of the complex process, the article of manufacture comprising:
a process monitor for providing training data representing a plurality of input variables and a plurality of corresponding process metrics;
a memory device for providing the function and a plurality of first weights corresponding to the at least one unknown parameter associated with each of the plurality of input variables in the portion; and
a data processing device in signal communication with the process monitor and the memory device, the data processing device receiving the training data, the function, and the plurality of first weights, determining an error signal for the non-linear regression model; and adjusting (i) the plurality of first weights and (ii) a plurality of second weights that relate the plurality of input variables to the plurality of process metrics, in a single process based on the error signal.

20. The article of manufacture of claim 19, wherein the function is non-linear with respect to the input variable.

21. The article of manufacture of claim 19, wherein the function is an activation function of the form
exp(−λⱼyⱼ)
and wherein the adjustment is of the form
Δλⱼ=−ηyⱼδⱼ
where λⱼ is the synaptic weight associated with an input yⱼ, the input yⱼ is an input variable in the portion, η is a learning rate parameter, δⱼ is the gradient of an output of a node j of the first hidden layer with the input yⱼ, and Δλⱼ is the adjustment for synaptic weight λⱼ associated with the input yⱼ.

22. The article of manufacture of claim 19 wherein the data processing device further determines if a convergence criterion is satisfied.

23. The article of manufacture of claim 19 wherein the process monitor comprises a database.

24. The article of manufacture of claim 19 wherein the process monitor comprises a memory device including a plurality of data files, each data file comprising a plurality of scalar numbers representing associated values for the plurality of input variables and the plurality of corresponding process metrics.

25. An article of manufacture for modeling a complex process having a plurality of input variables, a portion of which have unknown behavior that can be described by a function comprising at least one unknown parameter and producing an output that is a predictor of outcome of the complex process, the article of manufacture comprising:
a process monitor for providing a plurality of input variables;
a memory device for providing a plurality of first connection weights that relate the plurality of input variables to a plurality of process metrics, the function, and a plurality of second connection weights corresponding to the at least one unknown parameter associated with each of the plurality of input variables in the portion; and
a data processing device in signal communication with the process monitor and the memory device, the data processing device receiving the plurality of input variables, the plurality of first connection weights, the function, and the plurality of second connection weights; and predict an outcome of the process in a single process using the plurality of input variables, the plurality of first connection weights, the function, and the plurality of second connection weights.
